(19) United States
(12) Patent Application Publication
(10) Pub. No.: US 2021/0284889 A1
(43) Pub. Date: Sep. 16, 2021

(54) ADHESIVE PRODUCTS USING OILSEED SOLIDS AND POLYISOCYANATES

(71) Applicant: The United States of America as Represented by the, Washington, DC (US)

(72) Inventors: Charles R. Frihart, Dane, WI (US); Linda F. Lorenz, Middleton, WI (US)

(21) Appl. No.: 17/197,956

(22) Filed: Mar. 10, 2021

Related U.S. Application Data
(60) Provisional application No. 62/988,000, filed on Mar. 11, 2020.

(51) Int. Cl. C09J 189/00

(52) U.S. Cl. CPC C09J 189/00; C08G 59/10

(57) ABSTRACT

Methods of making and using adhesive compositions based on oilseed solids are provided. Also provided are adhesive compositions made using the methods. The adhesive compositions are made by mixing defatted oilseed solids with a polyisocyanate to form a non-aqueous adhesive composition and, subsequently, mixing the non-aqueous adhesive composition with water to form an aqueous adhesive composition.

### CROSS-REFERENCE TO RELATED APPLICATIONS

The present application claims priority to U.S. provisional patent application No. 62/988,000 that was filed Mar. 11, 2020, the entire contents of which are incorporated herein by reference.

### BACKGROUND

Plant proteins have been used as adhesives for thousands of years, including for wood bonding. Fossil fuel-derived adhesives with superior performance, especially in water resistance, displaced proteins in the mid-20^{th} century. More recently, concerted efforts have been made to use more bio-based adhesives, including plant flour-based adhesives. However, since plant flour adhesives do not give sufficient wet bond strength by themselves, some type of additional co-reactant or cross linker is typically added to the flour to improve performance. Some cross linkers, such as aldehydes, phenol-formaldehyde (PF), polyamidoamine-epichlorohydrin (PAE) resin, and magnesium oxide, are simply mixed into aqueous flour dispersions. It has been shown that up to 30% soy flour can be combined with either poly(diphenylmethylene diisocyanate) (pMDI) or PF adhesive with little property loss. (Hand, W. G. et al. (2018) International Journal of Adhesion and Adhesives, 87:105-108.) A number of methods have been claimed for increasing the strength of soy-based adhesives, with the addition of PAE being the most commercially common method. (Frihart, C. R. & Lorenz, L. F. (2019) Journal of Polymer Science Part A: Polymer Chemistry, 57:1017-1023; Shi, S. et al. (2017) Modification of soy-based adhesives to enhance the bonding performance. In Bio-based wood adhesives: Preparation, characterization, and testing, ed. Z. He. Boca Raton, Fla.: CRC Press; Vnučec, D. et al. (2017) Journal of Adhesion Science and Technology, 31: 910-931; He, Z. (2017) Bio-based wood adhesives: Preparation, characterization, and testing. Boca Raton, Fla.: CRC Press, PP 366.) PAE is also used in the commercial soy adhesive Soyad™. (Alien, A J. et al (2010) Forest Products Journal, 60(6), 534-540; and B. Adhikari et al., Protein-Based Wood Adhesives: Current Trends of Preparation and Application. In: Bio-Based Wood Adhesives: Preparation, Characterization, and Testing, ed. by Z. He (CRC Press, Boca Raton, Fla. 2017.) Unlike soy, there is little available information on the bonding properties of canola flour or other non-soy oilseed flours with pMDI or PAE.

Relative to the literature related to the use of PAE in wood bonding, the literature related to the use of pMDI with proteins for wood bonding is much more limited, and the studies that are available react pMDI with low molecular weight, purified proteins. (Adhikari et al. 2017; and Cheng et al. (2019) Forest Products Journal, 69: 154-158.)

### SUMMARY

Compositions based on oilseed solids and polyisocyanates for use as adhesives are provided. Also provided are methods of making the adhesive compositions and methods of using the compositions to bond substrates.

One embodiment of a composition includes: defatted oilseed solids; and a polyisocyanate, wherein the composition is a particulate solid, and the defatted oilseed solids and the polyisocyanate make up at least 95 weight percent of the composition.

One embodiment of a method of making an adhesive composition includes the steps of: mixing a particulate solid composition comprising defatted oilseed solids and a polyisocyanate to form a non-aqueous adhesive composition; and mixing the non-aqueous adhesive composition with water to form an aqueous adhesive composition.

One embodiment of a method of bonding substrates includes the steps of: mixing a particulate solid composition comprising defatted oilseed solids and a polyisocyanate to form a non-aqueous adhesive composition; mixing the non-aqueous adhesive composition with water to form an aqueous adhesive composition; applying the aqueous adhesive composition to a surface of at least one of the substrates; and pressing the applied adhesive composition between the substrates.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 shows a schematic illustration of bonding and testing with ABES. (ASTM_International. (2015) D7998-15 Standard test method for measuring the effect of temperature on the cohesive strength development of adhesives using lap shear bonds under Tensile Loading.)

FIG. 2 shows shear strengths of modified canola and soy adhesives bonded at 120° C., where the H₂O and pMDI were added in the order stated. The percent soy or canola represents the final mixture weight percent, and the weights of additives were based upon the dry canola and soy weights.

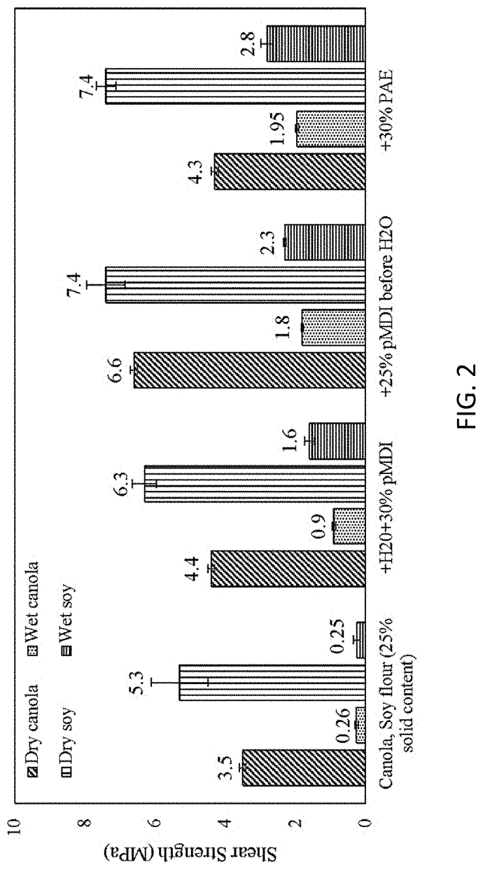

FIGS. 3A-3C show illustrations of reactions between isocyanate and protein (FIG. 3A, FIG. 3B), and water (FIG. 3C).

FIG. 4, reactions A, B, and C, show a major cross-linking mechanism between PAE and proteins (P). FIG. 4, reaction A, shows self-reaction; FIG. 4, reaction B, shows protein carboxylic groups; FIG. 4, reaction C, shows protein amino groups.

FIG. 5 shows shear strength of canola (C) and soy (S) flour, where the H₂O and pMDI are added in the order stated. The percent soy or canola represents the final mixture weight percent, and the weights of additives were based upon the canola and soy weights.

### DETAILED DESCRIPTION

Methods of making and using adhesive compositions based on oilseed solids are provided. Also provided are adhesive compositions made using the methods.

One embodiment of a method of making an oilseed solids-based adhesive composition includes the steps of mixing defatted oilseed solids with a polyisocyanate to form a non-aqueous adhesive composition and, subsequently, mixing the non-aqueous adhesive composition with water to form an aqueous adhesive composition. The aqueous adhesive compositions can be used to bond substrates by applying the aqueous adhesive composition to a surface of at least one of the two or more substrates; and pressing the applied adhesive composition between the substrates. As used herein, the term “non-aqueous” refers to a solution or other composition in which water is not present in bulk form, such as in the form of a solvent in a solution. However, a non-aqueous composition need not have a water content of zero because the composition may contain a small amount of water that is adsorbed from the air in the surrounding environment.

The methods and adhesive compositions described herein are based, at least in part, on the inventors' discovery that by mixing defatted oilseed solids with a polyisocyanate crosslinker to form a non-aqueous composition, followed by the addition of water at some later time, the cohesive strength of the resulting adhesive composition can be substantially improved, relative to an analogous adhesive composition that is formed by adding the water to the oilseed solids, followed by the addition of the polyisocyanate. Although the inventors do not intend to be bound to any particular theory of the invention, it is proposed that rapid reactions between the polyisocyanate and water lead to self-curing before the polyisocyanate has time to penetrate into the compact globular oilseed proteins and react with the protein functional groups. Thus, adding the polyisocyanate to the oilseed solids before adding any water promotes reactions between the oilseed solids and the polyisocyanates, which improves the bonding strength of the adhesive composition.

Oilseeds are plant seeds that have a fatty oil content of over 20 wt. %, from which the fatty oils can be extracted. Oilseeds include soybeans, rapeseeds, such as canola seeds, sunflower seeds, corn kernels, cotton seeds, flax seeds, peanuts, palm kernels, copra seeds, and coconuts. As used herein, the term ‘defatted oilseed solids’ refers to the solid material remaining after fatty oils are removed from the oilseeds. Removing the fatty oils (i.e., defatting) the oilseeds can be accomplished, for example, by pressing or solvent extraction. Defatting removes most of the fatty oils from the oilseeds. However, the defatted oilseed solids may retain a small residual fatty oil content, typically less than 10 wt. % and more typically 5 wt. % of lower, even after defatting. Optionally, the oilseeds from which the defatted oilseed solids are produced may be dehulled. The defatted oilseed solids may undergo comminution to various degrees after defatting in order to reduce the average particle size of the solids to form flakes, course particulates, or finely ground powders. Thus, defatted oilseed solids include solids materials that are commonly referred to in the art as oilseed flour and oilseed meals.

The polyisocyanates used in the adhesive compositions are organic molecules that include two or more isocyanate groups. Suitable polyisocyanates include aromatic isocyanate molecules and aliphatic isocyanate molecules, including diisocyanate monomers or polymers. Common isocyanates include hexamethylene diisocyanate (HMDA) and methylenediphenyl diisocyanate (MDI), along with its by-product polymethylenediphenyl diisocyanate (pMDI).

The defatted oilseed solids will be the majority component in the non-aqueous adhesive composition, making up greater than 50 weight percent (wt. %) of the composition. However, the weight ratio of the defatted oilseed solids to the polyisocyanate can be varied. Increasing the concentration of the polyisocyanate, starting from a low concentration, may increase the dry and/or wet shear strength of the adhesives. Therefore, various embodiments of the non-aqueous adhesive compositions have a polyisocyanate content in the range from 5 wt. % to 100 wt. %, based on the weight of the defatted oilseed solids. This includes non-aqueous adhesive compositions having a polyisocyanate content in the range from 10 wt. % to 40 wt. %, based on the weight of the defatted oilseed solids, and further includes non-aqueous adhesive compositions having a polyisocyanate content in the range from 20 wt. % to 35 wt. %, based on the weight of the defatted oilseed solids.

The oilseed solids and polyisocyanate may be the only components in the non-aqueous adhesive composition. However, it is also possible to include small amounts of additives that do not act as crosslinkers in the mixture. Thus, some embodiments of the non-aqueous adhesive compositions consist of only the oilseed flours and the polyisocyanates, while other embodiments include minor amounts of other components—typically at concentrations of less than 10 weight percent (wt. %), less than 5 wt. %, or less than 2 wt. %. Examples of additives include surfactants, defoamers, chaotropic compounds, and viscosity reducers, such as sodium metabisulfite.

Notably, although substantial quantities of liquid polyisocyantes can be combined with the defatted oilseed solids to form the non-aqueous adhesive compositions, said compositions take the form of a particulate solid, such as a fine free-flowing dry powder, rather than a viscous fluid. This is advantageous because it overcomes two previously unaddressed problems with liquid polyisocyanates, such as pMDI—namely that liquid polyisocyanates can bleed through veneer layers in plywood and can adhere to platens in composite pressing (e.g., in the manufacture of particleboard, medium density fiberboard, and oriented strandboard). The particulate solids can be easily handled and can be stored under ambient conditions prior to mixing with the water. Although ambient conditions may vary somewhat from location to location, they will generally include temperatures in the range from 15° C. to 27° C., relative humidities in the range from 30% to 50%, and normal atmospheric pressures. As illustrated in the Examples, storing the mixture of oilseed solids and polyisocyanate for a period of time before adding water can significantly increase the wet shear strength of the adhesive. By way of illustration, storage periods of 10 minutes to two weeks, including storage periods of 10 minutes to 24 hours can be used. However, shorter or longer periods of storage can also be used.

Optionally, a secondary crosslinker can be included in the aqueous adhesive composition. This can be accomplished by including the secondary crosslinker in the water that is added to the oilseed solids-polyisocyanate mixture, or by adding the secondary crosslinker after that mixture has been added to water. Amine-epichlorohydrin polymers are examples of secondary crosslinkers that can be included in the aqueous adhesive compositions. Amine-epichlorohydrins, which are reaction products of amines and epichlorohydrins, include polyamidoamine-epichlorohydrin resins. Polyamidoamine-epichlorohydrin resins are characterized by azetidinium and amide functional groups along the polymer backbone. Other secondary crosslinkers that can be used in the aqueous adhesive compositions include formaldehyde, glyoxal, glutaraldehyde, furan dialdehyde, diepoxy crosslinkers, and the like.

The weight ratio of the defatted oilseed solids to the secondary crosslinker can be varied. Increasing the concentration of the secondary crosslinker, starting from a low concentration, may increase the dry and/or wet shear strength of the final adhesive. However, this increase may level out as the secondary crosslinker concentration continues to increase. Therefore, various embodiments of the aqueous adhesive compositions have secondary crosslinker content in the range from 1 wt. % to 30 wt. %, based on the weight of the defatted oilseed solids. This includes aqueous adhesive compositions having an amine-epichlorohydrin polymer content in the range from 2 wt. % to 15 wt. %, based on the weight of the defatted oilseed solids. By way of illustration, some embodiments of the aqueous adhesive compositions have a polyamidoamine-epichlorohydrin resin content in the above-recited ranges.

The adhesive compositions described herein can be used to bond various substrates, but are particularly suited for bonding wood substrates, including hardwood and softwood substrates. Suitable wood types include maple, oak, birch, poplar, pine, spruce, fir, beech, and hickory. The adhesive compositions also can act as a binder resin in the production of particleboard or fiberboard. The cohesive strength of the bond provided by the adhesive compositions can be measured using the standardized test ASTM D7998-15 published by ASTM International in 2015 and entitled, “Standard Test Method for Measuring the Effect of Temperature on the Cohesive Strength Development of Adhesives using Lap Shear Bonds under Tensile Loading.”

### EXAMPLE

This example demonstrates how mixing a defatted soy or canola flour with a pMDI crosslinker prior to the addition of water enhances the cohesive shear strength of the resulting adhesive compositions. The small-scale adhesive strength test ASTM D-7998 (2015) was used to compare the performance of the different adhesives. The more challenging wet cohesive bond strength is emphasized here, because the dry strengths were usually very good. Generally, soy-based adhesives were better than canola-based adhesives and the addition of a polyamidoamine-epichlorohydrin (PAE) cross-linker improved performance.

Table 1 shows the compositions of a defatted canola flower and a defatted soy flour, as reported by Li, N. et al. (2017a) Canola protein and oil-based wood adhesives. In Bio-based Wood Adhesives: Preparation, Characterization, and Testing ed. Z. He. Boca Raton, Fla.: CRC Press; and Wolf, W. J. (1970) Journal of Agricultural and Food Chemistry, 18: 969-976.

TABLE 1
Composition of defatted canola flour and soy flour.

| | Canola | Soy |
|---|---|---|
| | flour | flour |
| Constituent | (%) | (%) |
| Protein (N × 6.25) | 35 | 55 |
| Carbohydrates | 35 | 34 |
| Remaining Fat | 2 | 2 |
| Ash | 6 | 6 |
| Other material | 22 | 3 |
| (Glucosinolates, erucic | | |
| acid, phytic acid, | | |
| phenolics, etc. in canola | | |
| flour., fiber in soy flour) | | |

Experimental Methods for Canola and Soy Testing

Materials. Defatted canola flour (Brassica napus L.) and defatted Prolia™ 200-90 soy flour were obtained from Behpak Industrial Co (Behshahr, Mazandaran, Iran) and Cargill Inc. (Cedar Rapids, Iowa), respectively. Columbia Forest Products supplied hard maple (Acer saccharum) veneer. The cross-linkers pMDI (Rubinate M) and PAE (CA1920 A) were provided by Huntsman (The Woodlands, Tex., USA) and Solenis (Wilmington, Del., USA), respectively.

Comparative Examples: Defatted soy flour or defatted canola flour was dispersed in deionized water at the required amount, and after mixing for about 5 minutes, the pMDI cross linker was added and the mixture was stirred for at least 10 minutes, except as noted.

Working Examples: Defatted soy flour or defatted canola flour was mixed with pMDI crosslinker with stirring for about 10 minutes. The resulting solid powder product was then added at some later time to deionized water and the aqueous mixture was stirred for about 10 minutes.

ABES Testing

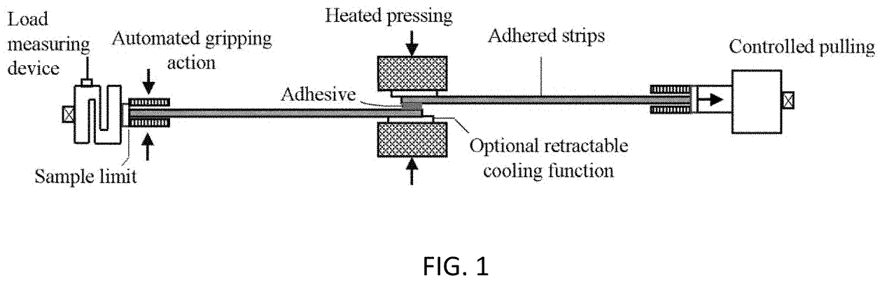

The adhesive compositions were applied to 5 mm on the end of one piece of hard maple (Acer saccharum) veneer (117×20×0.6 mm), which was overlapped 5 mm with another piece of veneer. Samples were hot pressed in the Automated Bonding Evaluation System (ABES) equipment (AES, Corvallis, Oreg.) at 0.2 MPa for 120 seconds at 120° C., see FIG. 1. Cohesive shear strength was determined in accordance with ASTM_International, 2015. D7998-15 Standard test method for measuring the effect of temperature on the cohesive strength development of adhesives using lap shear bonds under tensile loading. The bonded wood samples were equilibrated at 21° C. and 50% relative humidity at least overnight before testing dry or wet after soaking in water for 4 hours at room temperature. Five specimens dry and wet were tested in tensile shear with the ABES. The average and one standard deviation are reported.

While the plywood tests are very valuable for validating final formulations, they are less useful in developing adhesive formulations and an understanding of strength development because they are sensitive to veneer quality, adhesive viscosity, adhesive penetration, open and closed assembly time, etc. This is why the present example used the small scale test ASTM D-7998 (ASTM_International 2015) using an ABES instrument, which emphasizes the cohesive strength of the adhesive compositions. With the smooth maple veneer, ABES specimens are less sensitive to gap filling, wood penetration, and lathe check issues than are standard plywood tests.

Various formulations of canola flour-based adhesives were tested for improved adhesive performance. These were tested using the ABES so that reliable comparisons could be made between the canola flour-based adhesives and soy flour-based adhesives.

Table 2 shows that in the comparative adhesives, canola flour provided lower dry shear strength than soy flour, and that both were low in wet strength. ABES samples were bonded with both canola flour and soy flour cross-linked with pMDI or with both pMDI and PAE. As noted above, in the comparative adhesives, the pMDI was initially added to canola flour or soy flour after the addition of water, which is the conventional method for laboratory modification of soy flour-based adhesives. However, since it was hypothesized that the poor strength increase was due to pMDI reacting rapidly with water, adding pMDI to the defatted flours before the water was also tried. Addition of pMDI to the flour before the water greatly improved both dry and wet strength.

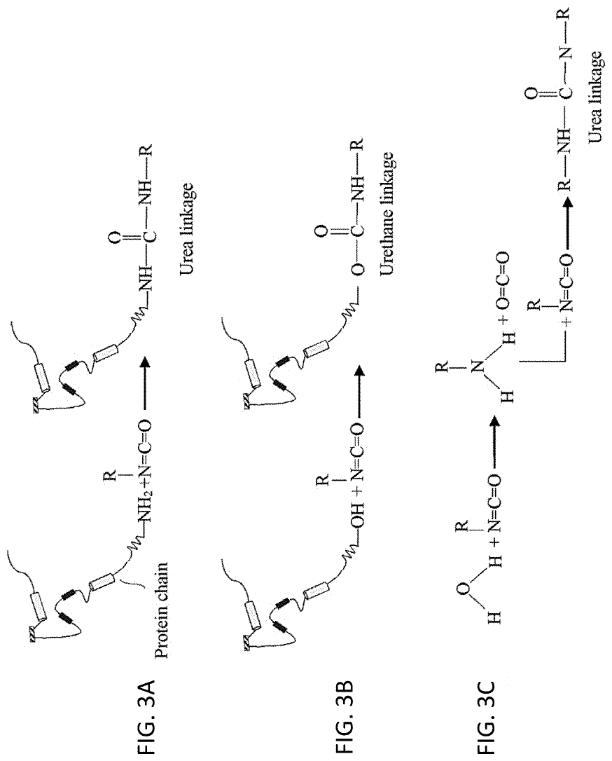

According to the literature, isocyanate groups can react with residual amino groups and free hydroxyl groups of proteins (FIG. 3A, FIG. 3B). (Gao, Z. et al. (2011) Journal of Applied Polymer Science, 120: 220-225.) Also, the water in the adhesive reacts with isocyanate (FIG. 3C). (Frazier, C. E. (2003) Isocyanate Wood Binders. In Handbook of Adhesive Technology, eds. A. Pizzi & K. Mittal, 681-694. New York: Marcel Dekker.)

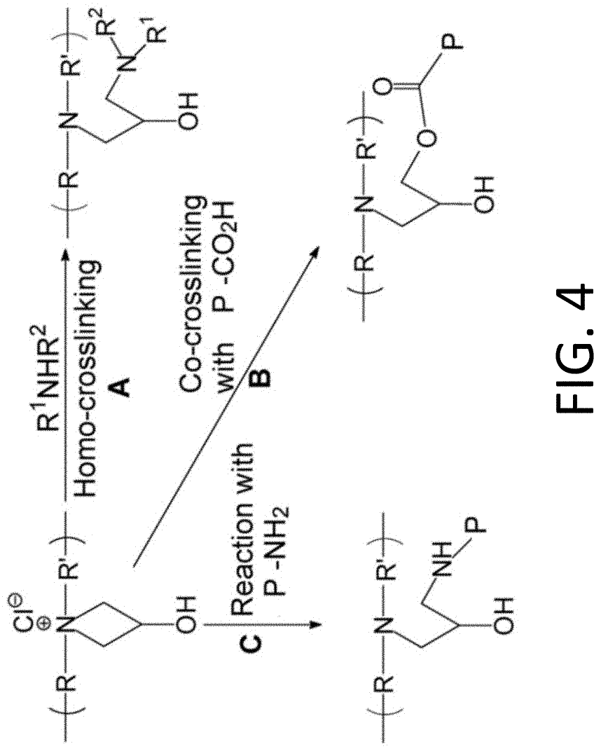

For the PAE cross-linker, crosslinking reactions are shown in FIG. 4, reactions A, B, and C. FIG. 4, reaction A, shows the reaction between azetidinium group in PAE and the remaining secondary amines in the PAE resin, resulting in homo-cross-linking, normally at pH above 6. FIG. 4, reaction B, shows how the azetidinium group might react with carboxylic acid groups. FIG. 4, reaction C, shows the cross-linking mechanism with various amino groups in canola flour or soy flour proteins and the azetidinium group. (Li, K. C. et al. (2004) Journal of the American Oil Chemists Society, 81: 487-491.) The reaction of PAE with the carboxylic acids of carbohydrates is well known, but the reaction of PAE with amines on proteins is more speculative. (Espy, H. H. (1995) TAPPI Journal, 78: 90-95.)

The pMDI and PAE crosslinkers are likely to form covalent bonds with both hydroxyl and carboxylic groups in the wood surface as well as those carboxylic and amino groups exposed on the protein surface. These bonds should produce good wet strength. However, unlike the PAE, the pMDI can react with the abundant water present in an aqueous formulation to form urea compounds instead of linking the proteins and carbohydrates. Thus, canola flour-based and soy flour-based adhesives were also made with pMDI, based on the weight of dry flour, which was 25% in the final formulation, added before and after the water.

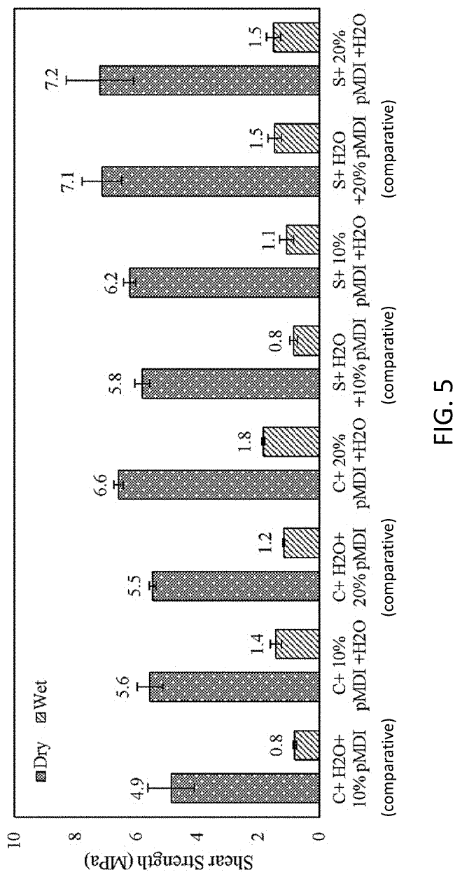

The resulting strength data in FIG. 5 shows that adding the different amounts of pMDI to the flour before the water gave better wet shear strengths. This information agrees with the concept that despite the high abundance of reactive groups in the oilseed proteins, these groups are probably less accessible, being buried in the globular proteins, while the water is very accessible for reaction. Giving the pMDI a chance to react with the oilseed proteins prior to competition with the water results in better cross linking.

In a series of additional examples, the cohesive shear strengths of canola flour-based adhesives and soy flour-based adhesives that were stored for different periods of time (from 1 day to 7 days) before the addition of water were determined. The comparative and working adhesive formulations are described below and the results of the studies are reported in Table 3. Here, again, wet and dry shear strength were measured using ASTM D7998-15 using the test set-up shown in FIG. 1.

Comparative example 1. To 75 ml of deionized water was added 25 g of Prolia™ 200-90 soy flour, then the mixture was stirred for at least 10 minutes.

Comparative example 2. To 75 ml of deionized water was added 25 g of Prolia™ 200-90 soy flour. After mixing for about 5 minutes, 3.75 g of Rubinate M polydimethylene diphenyl diisocyanate (pMDI) was added and the mixture was stirred for at least 10 minutes.

Comparative example 3. To 75 ml of deionized water was added 25 g of Prolia™ 200-90 soy flour. After mixing for about 5 minutes, 12.5 g of Rubinate M pMDI was added and the mixture was stirred for at least 10 minutes.

Working example 4. 25 g Prolia™ 200-90 soy flour was reacted with 12.5 g of Rubinate M pMDI. After mixing for about 10 minutes, this powdered product of soy flour and pMDI was added to 75 ml of deionized water and the mixture was stirred for at least 10 minutes.

Working example 5. Samples of the soy flour/pMDI adhesive powder from example 4 were stored at ambient conditions for (A) 1 day (B) 3 days (C) 1 week (D) 2 weeks, prior to adding them to 75 ml of deionized water each and stirring the mixture for at least 10 minutes.

Comparative example 6. To 75 ml of deionized water was added 25 g of Behpak Industrial Co defatted canola flour, then the mixture was stirred for at least 10 minutes.

Comparative example 7. To 75 ml of deionized water was added 25 g of Behpak Industrial Co defatted canola soy flour. After mixing for about 5 minutes, 2.5 g of Rubinate M polydimethylene diphenyl diisocyanate (pMDI) was added and the mixture was stirred for at least 10 minutes.

Comparative example 8. To 75 ml of deionized water was added 25 g of Behpak Industrial Co defatted canola soy flour. After mixing for about 5 minutes, 12.5 g of Rubinate M pMDI was added and the mixture was stirred for at least 10 minutes.

Working example 9. 25 g Behpak Industrial Co defatted canola soy flour was reacted with 12.5 g of Rubinate M pMDI. After mixing for about 10 minutes, this powdered product of canola flour and pMDI was added to 75 ml of deionized water and the mixture was stirred for at least 10 minutes.

Working example 10. Samples of the canola flour/pMDI adhesive powder from example 9 were stored at ambient conditions for (A) 1 day (B) 3 days (C) 1 week (D) 2 weeks, prior to adding them to 75 ml of deionized water each and stirring the mixture for at least 10 minutes.

Each adhesive composition was applied to 5 mm on the end of one piece of hard maple (Acer saccharum) veneer (117×20×0.6 mm), which was overlapped 5 mm with another piece of veneer. Test pieces were hot pressed in the Automated Bonding Evaluation System (ABES) equipment at 0.2 MPa for 120 seconds at 120° C., see FIG. 1. The bonded wood test pieces were equilibrated at 21° C. and 50% relative humidity at least overnight before testing dry or wet after soaking in water for 4 hours at room temperature. Five specimens dry and wet were tested in tensile shear with the ABES. The average and one standard deviation are reported.

TABLE 2
ABES bond shear strength in
MPa according to the above, with CE representing
comparative examples and WE representing working examples.

| | | | Dry | Wet |
|---|---|---|---|---|
| Example Number | Flour type | % pMDI added^{a} | strength | strength |
| CE 1 | soy | 0 | 5.3 | 0.3 |
| CE 2 | soy | 15 | 5.6 | 1.1 |
| CE 3 | soy | 50 | 7.0 | 2.7 |
| WE 4 | soy | 50 | 8.1 | 3.4 |
| WE 5-A | soy | 50-1 day | 6.8 | 3.4 |
| WE 5-B | soy | 50-5 days | 5.6 | 2.6 |
| WE 5-C | soy | 50-1 week | 5.6 | 1.7 |
| WE 5-D | soy | 50-2 weeks | 5.3 | 1.6 |
| CE 6 | canola | 0 | 4.5 | 0.2 |
| CE 7 | canola | 10 | 4.9 | 0.8 |
| CE 8 | canola | 50 | 5.5 | 2.7 |
| WE 9 | canola | 50 | 8.8 | 3.5 |
| WE 10-A | canola | 50-1 day | 8.8 | 4.3 |
| WE 10-B | canola | 50-5 days | 7.5 | 3.1 |
| WE 10-C | canola | 50-1 week | 7.0 | 2.6 |
| WE 10-D | canola | 50-11 days | 7.0 | 1.9 |

^{a}Based upon the weight of flour

A comparison between comparative examples 2 and 3 shows that adding the pMDI to an aqueous dispersion of soy flour in water improves dry and wet strength. However, reacting the pMDI first with soy flour, and adding water at a later time (working examples 4 and 5) gave greater wet strength, although as the reaction progressed the overall effect decreased. Surprisingly, adding the viscous liquid pMDI to the powdered soy flour resulted in a free-flowing powder instead of a sticky mess. The same was observed with canola flour, although it took a day of reaction to reach the same point and the effect tailed off sooner.

In another series of additional examples, the cohesive shear strengths of canola flour-based adhesives and soy flour-based adhesives that were stored for different periods of time (from 1 day to 7 days) before the addition of water and a PAE crosslinker were studied. The comparative and working adhesive formulations are described below and the results of the studies are reported in Table 3. Here, again, wet and dry shear strength were measured using ASTM D7998-15 using the test set-up shown in FIG. 1.

Comparative example 11. To 68.75 ml of deionized water was added 25 g of Prolia™ 200-90 soy flour. After mixing for about 5 minutes, 6.25 g of Solenis CA1920 A containing 1.25 g of polyamidoamine-epichlorohydrin (PAE) was added and the mixture was stirred for at least 10 minutes.

Comparative example 12. To 60 ml of deionized water was added 25 g of Prolia™ 200-90 soy flour. After mixing for about 5 minutes, 18.75 g of Solenis CA1920 A containing 3.75 g of PAE was added and the mixture was stirred for at least 10 minutes.

Comparative example 13. To 37.5 ml of deionized water was added 25 g of Prolia™ 200-90 soy flour. After mixing for about 5 minutes, 37.5 g of Solenis CA1920 A containing 7.5 g of PAE was added and the mixture was stirred for at least 10 minutes

Working example 14. First 25 g Prolia™ 200-90 soy flour was reacted with 12.5 g of Rubinate M pMDI. After thorough mixing for about 10 minutes, this powdered product of soy flour and pMDI was added to 68.75 ml of deionized water and 6.25 g of Solenis CA1920 A containing 1.25 g of PAE and the mixture was stirred for at least 10 minutes.

Working example 15. Working example 14 was repeated, except that the reaction time of the soy flour plus pMDI powder was one day before adding PAE and water.

Working example 16. Working example 14 was repeated, except that the reaction time of the soy flour plus pMDI powder was two days before adding PAE and water.

Working example 17. Working example 14 was repeated, except that the reaction time of the soy flour plus pMDI powder was three days before adding PAE and water.

Working example 18. Working example 14 was repeated, except that the reaction time of the soy flour plus pMDI powder was five days before adding PAE and water.

Working example 19. Working example 14 was repeated, except that the reaction time of the soy flour plus pMDI powder was seven days before adding PAE and water.

Comparative examples 20-22 are analogous to comparative examples 11-13, except that defatted canola flour was used instead of defatted soy flour and the amount of PAE added differed in some cases, as shown in Table 3. Working examples 23-28 are analogous to comparative examples 14-19, except that defatted canola flour was used instead of defatted soy flour.

TABLE 3
ABES bond shear strength in MPa according to the
procedure described above, with CE representing comparative
examples and WE representing working examples.

| Example | | % PAE | | |
|---|---|---|---|---|
| Number | Flour type and amount | added | Dry strength | Wet strength |
| CE 11 | 25% soy flour | 5 | 6.6 | 2.9 |
| CE 12 | 25% soy flour | 15 | 8.6 | 3.5 |
| CE 13 | 25% soy flour | 30 | 7.4 | 2.8 |
| WE 14 | 2:1 soy:pMDI | 0 | 8.1 | 3.4 |
| WE 15 | 2:1 soy:pMDI | 5 | 7.9 | 4.9 |
| WE 16 | 2:1 soy:pMDI | 5 | 6.8 | 4.8 |
| WE 17 | 2:1 soy:pMDI | 5 | 6.9 | 4.7 |
| WE 18 | 2:1 soy:pMDI | 5 | 7.8 | 4.0 |
| WE 19 | 2:1 soy:pMDI | 5 | 7.2 | 3.4 |
| CE 20 | 25% canola flour | 10 | 6.4 | 1.9 |
| CE 21 | 25% canola flour | 20 | 6.5 | 2.0 |
| CE 22 | 25% canola flour | 30 | 6.2 | 1.8 |
| WE 23 | 2:1 canola:pMDI | 0 | 8.8 | 3.5 |
| WE 24 | 2:1 canola:pMDI | 5 | 9.8 | 5.6 |
| WE 25 | 2:1 canola:pMDI | 5 | 8.9 | 5.5 |
| WE 26 | 2:1 canola:pMDI | 5 | 8.4 | 5.1 |
| WE 27 | 2:1 canola:pMDI | 5 | 8.4 | 4.1 |
| WE 28 | 2:1 canola:pMDI | 5 | 7.6 | 4.0 |

Analysis: The PAE provided improved wet adhesive strength to the soy flour-based adhesives in CE 11 to CE 13 compared to soy flour-based adhesive CE 1 and to the addition of pMDI only in the aqueous soy flour-based adhesives of CE 2 and CE 3. The effect levels off and even decreases with increasing PAE levels in CE 11 to 13. Surprisingly the addition of the soy flour-pMDI powder to an aqueous PAE solution provided enhanced wet strength beyond that achievable by any amount of the PAE or pMDI separately. This effect was greatest after the soy flour-pMDI non-aqueous composition was stored from 1 to 7 days prior to the addition of water and PAE. The effect was equal or stronger with the canola flour-based adhesive.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A composition comprising:
defatted oilseed solids; and
a polyisocyanate, wherein the composition is a particulate solid, and the defatted oilseed solids and the polyisocyanate make up at least 90 weight percent of the composition.

2. The composition of claim 1 having a polyisocyanate content in the range from 10 wt. % to 100 wt. %, based on the weight of the defatted oilseed solids.

3. The composition of claim 1, wherein the polyisocyanate is poly(diphenylmethylene diisocyanate).

4. The composition of claim 1, wherein the defatted oilseed solids and the polyisocyanate make up at least 98 weight percent.

5. The composition of claim 1, wherein the defatted oilseed solids are defatted soy solids or defatted canola solids.

6. The composition of claim 5, wherein the polyisocyanate is poly(diphenylmethylene diisocyanate).

7. The composition of claim 6, wherein the composition consists of the defatted soy solids and the poly(diphenylmethylene diisocyanate).

8. A method of making an adhesive composition, the method comprising:
mixing a particulate solid composition comprising defatted oilseed solids and a polyisocyanate to form a non-aqueous adhesive composition; and
mixing the non-aqueous adhesive composition with water to form an aqueous adhesive composition.

9. The method of claim 8, wherein the non-aqueous adhesive composition has a polyisocyanate content in the range from 10 wt. % to 100 wt. %, based on the weight of the defatted oilseed solids.

10. The method of claim 8, further comprising storing the non-aqueous adhesive composition for a period of 10 minutes to 24 hours before mixing the non-aqueous adhesive composition with the water.

11. The method of claim 8, further comprising mixing an amine epichlorohydrin polymer into the aqueous adhesive composition.

12. The method of claim 11, wherein the aqueous adhesive composition has an amine epichlorohydrin polymer content in the range from 1 wt. % to 15 wt. %, based on the weight of the defatted oilseed solids.

13. The method of claim 11, wherein the polyisocyanate is poly(diphenylmethylene diisocyanate).

14. The method of claim 8, wherein the polyisocyanate is poly(diphenylmethylene diisocyanate).

15. The method of claim 8, wherein the defatted oilseed solids are defatted soy solids or defatted canola solids.

16. The method of claim 15, wherein the polyisocyanate is poly(diphenylmethylene diisocyanate).

17. An adhesive composition made according to the method of claim 8.

18. A method of bonding substrates, the method comprising:
mixing a particulate solid composition comprising defatted oilseed solids and a polyisocyanate to form a non-aqueous adhesive composition;
mixing the non-aqueous adhesive composition with water to form an aqueous adhesive composition;
applying the aqueous adhesive composition to a surface of at least one of the substrates; and
pressing the applied adhesive composition between the substrates.

19. The method of claim 18, wherein the non-aqueous adhesive composition has a polyisocyanate content in the range from 10 wt. % to 50 wt. %, based on the weight of the defatted oilseed solids.

20. The method of claim 18, wherein the two substrates are wood substrates.
